(19) United States
(12) Patent Application Publication
(10) Pub. No.: US 2015/0138608 A1
(43) Pub. Date: May 21, 2015

(54) System and Method for Printing a Hidden and Secure Barcode

(71) Applicant: CTPG Operating, LLC, Ithaca, NY (US)

(72) Inventors: Kyle Turner, Lake Forest, IL (US); Robert Delaney, Ithaca, NY (US); Joseph Howe, Ithaca, NY (US); John Hall-Thurnheer, Ithaca, NY (US)

(73) Assignee: CTPG OPERATING, LLC, Ithaca, NY (US)

(21) Appl. No.: 14/541,636

(22) Filed: Nov. 14, 2014

Related U.S. Application Data
(60) Provisional application No. 61/904,655, filed on Nov. 15, 2013.

(51) Int. Cl. G06K 1/12; H04N 1/44; H04N 1/00; G06K 15/00; G06K 15/02

(52) U.S. Cl. CPC G06K 1/121; G06K 15/4095; G06K 15/189; H04N 1/00864; H04N 1/4446; H04N 1/448
USPC 358/3.28; 358/448

(57) ABSTRACT

The present invention relates to systems and methods for printing a hidden and secure barcodes and, more particularly, to digital printers structured, configured, and/or programmed to print a set of unique non-standard symbols for the purpose of representing a data string based on a barcode standard that can be hidden in the background of a media substrate.

### RELATED APPLICATION DATA

The present application claims the benefit of U.S. provisional patent application No. 61/904,655, filed Nov. 15, 2013, and is hereby incorporated by reference in its entirety.

### BACKGROUND OF THE INVENTION

1. Field of the Invention

The present invention relates to systems and methods for printing a hidden and secure barcodes and, more particularly, to digital printers structured, configured, and/or programmed to print a set of unique non-standard symbols for the purpose of representing a data string based on a barcode standard that can be hidden in the background of a media substrate.

2. Description of the Related Art

Security printing relates to the practice of manufacturing media substrate with certain security indicia/features to prevent forgery and counterfeiting of items such as passports, checks, and prescription pads. Security printing techniques are used across a diverse marketplace to deter fraud, counterfeiting, and theft. Interpol estimates that worldwide counterfeit goods represent 5 to 7 percent of all world trade or $600 million annually. Security printing helps to ensure the authenticity of a product or service. In industries that use barcodes to identify transactions on receipts or to identify inventory items with labels, copy fraud is a big problem.

In the retail industry, for example, a receipt is normally issued with a barcode as a record of the transaction. In these transactions, it is very hard for a thief to copy the receipt and use it in an attempt to defraud the retailer because the barcode is part of a closed loop with the transaction recorded in a database. However, there are some transactions and some retailers that do not have a closed loop system. For these transactions, a thief can make a copy of the receipt, change the amount of the transaction and defraud the retailer when returning or redeeming the item, for example. A retailer can use expensive security media to print the receipts with various security features (such as preprinted pantographs) built into the media. The cost of security media, however, is very high and if this media is stolen from the retailer a thief may be able to print secure receipts fraudulently without detection.

Product labeling faces similar problems with copy fraud. Items in inventory often contain a barcode label for identification. These counterfeit items can carry duplicates of the barcode identification label. As a result, the industry has turned to using expensive specialty inks and security features embedded in the media to combat counterfeit products.

Pharmacies/Physicians issue prescriptions using laser or inkjet printers with security features embedded in the media. This has created significant fraud opportunities to abuse prescription narcotics. If the security media is stolen, the thief is able to use a commonly available laser or ink jet printers to print the fraudulent narcotics prescriptions without detection.

RFID technology is available for use to prevent fraud. The RFID tag can be attached to the product label to give the item a unique identifying number, which is used to prevent counterfeiting. If a fraudulent item is brought into a store, it is unlikely to have the correct unique number in an RFID tag. Other solutions involve using embedded security features in the print media or preprinting security patterns on media.

RFID tags and preprinted media are very expensive. Media with embedded security features must be locked up so that a thief cannot get copies to print fraudulent documents.

Description of the Related Art Section Disclaimer: To the extent that specific patents/publications/products are discussed above in this Description of the Related Art Section or elsewhere in this application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### SUMMARY OF THE INVENTION

The present invention recognizes the potential problems and/or disadvantages with the conventional technology used in the manufacturing of media substrate with certain security indicia/features (as described above). Various embodiments of the present invention may be advantageous in that they may solve or reduce one or more of the potential problems and/or disadvantages.

Various embodiments of the present invention may exhibit one or more of the following objects, features and/or advantages:

It is therefore a principal object and advantage of the present invention to provide a digital printer that is structured, configured, and/or programmed to print a group of non-standard unique symbols that are unlike any characters found in industry standard font sets.

It is another object and advantage of the present invention to provide a digital printer that is structured, configured, and/or programmed to convert a specific data string (which can be user selected, or automatically selected per printer firmware or a host device connected to the digital printer) to the unique symbols based on a standard barcode standard.

It is another object and advantage of the present invention to provide a digital printer that is structured, configured, and/or programmed to print a constant noise pattern on top of the unique symbols to make them less obvious to the untrained observer.

It is another object and advantage of the present invention to provide a digital printer that is structured, configured, and/or programmed to reduce the optical density of the digitally printed symbols by reducing pixels used to make them less obvious to the untrained observer.

It is another object and advantage of the present invention to provide a digital printer that is structured, configured, and/or programmed to separate the unique symbol string into individual cell locations on the digital media background to make them less obvious to the untrained observer.

It is another object and advantage of the present invention to provide a software application configured to be stored on and used in conjunction with a mobile device or other computing device (“imaging device”), and is programmed with an algorithm which provides the imaging device with the ability to scan, identify/interpret, and validate the non-standard symbols set forth as a string located in the background of the digital media (with or without the assistance of a connected host computer).

In accordance with the foregoing objects and advantages, an embodiment is directed to computer implemented method for digitally printing a non-standard symbol string representing a data string on a media substrate, which can include the implementation of one or more algorithms that can be programmed into the printer firmware (which is discussed in detail in the detailed description section below). The method can comprise, but is not limited to, the steps of: accepting a data string comprising at least one number, letter, or standard symbol; converting the data string to a barcode value; converting the barcode value to a non-standard symbol value, wherein the non-standard symbol value is represented by at least one non-standard symbol; and digitally printing the at least one non-standard symbol on a media substrate.

In one embodiment of the method, the step of accepting further comprises the step of accepting a data string comprising a plurality of any combination of at least one number, letter, or standard symbol.

In one embodiment of the method, the step of converting the data string to a barcode value further comprises the step of converting each of the plurality of any combination of at least one number, letter, or standard symbol to a separate barcode value.

In one embodiment of the method, the step of converting the barcode value to a non-standard symbol value further comprises the step of converting each separate barcode value to a corresponding separate non-standard symbol value, wherein each of the corresponding separate non-standard symbol values is represented by at least one non-standard symbol.

In one embodiment of the method, the method further comprises the step of merging each of the corresponding separate non-standard symbol values in a first order sequence.

In one embodiment of the method, the step of digitally printing further comprises the step of digitally printing the non-standard symbols in the first order sequence on the media substrate.

In one embodiment of the method, the method further comprises the step of reducing optical density of the at least one non-standard symbol.

In one embodiment of the method, the method further comprises the step of parsing the non-standard symbols into different predetermined cells in the background of the digital media.

In one embodiment of the method, the method further comprises the step of printing a constant noise pattern on top of the at least one non-standard symbol.

In accordance with an additional embodiment, there is provided a non-transitory computer-readable storage medium containing program code that can include, but is not limited to program code for accepting a data string comprising at least one number, letter, or standard symbol; program code for converting the data string to a barcode value; program code for converting the barcode value to a non-standard symbol value, wherein the non-standard symbol value is represented by at least one non-standard symbol; and program code for digitally printing the at least one non-standard symbol on a media substrate. The non-transitory computer-readable storage medium containing program code can include a host computer connected to a printer, a portion of the printer that contains firmware, or a combination of the two.

In one embodiment of the non-transitory computer-readable storage medium, the non-transitory computer-readable storage medium further comprises program code for accepting a data string comprising a plurality of any combination of at least one number, letter, or standard symbol.

In one embodiment of the non-transitory computer-readable storage medium, the non-transitory computer-readable storage medium further comprises program code for converting each of the plurality of any combination of at least one number, letter, or standard symbol to a separate barcode value.

In one embodiment of the non-transitory computer-readable storage medium, the non-transitory computer-readable storage medium further comprises program code for converting each separate barcode value to a corresponding separate non-standard symbol value, wherein each of the corresponding separate non-standard symbol values is represented by at least one non-standard symbol.

In one embodiment of the non-transitory computer-readable storage medium, the non-transitory computer-readable storage medium further comprises program code for merging each of the corresponding separate non-standard symbol values in a first order sequence.

In one embodiment of the non-transitory computer-readable storage medium, the non-transitory computer-readable storage medium further comprises program code for digitally printing the non-standard symbols in the first order sequence on the media substrate.

In accordance with an additional embodiment, there is provided a computer implemented method for revealing and validating a data string represented by at least one non-standard symbol printed on a media substrate, the method comprising: scanning a media substrate comprising at least one printed non-standard symbol thereon; identifying the at least one printed non-standard symbol, wherein the at least one printed non-standard symbol is represented by a non-standard symbol value; converting the non-standard symbol value to a barcode value; and converting the barcode value to a data string comprising at least one number, letter, or standard symbol.

In one embodiment of the method, the method further comprises the step of assigning a value to each printed non-standard symbol, when the media substrate comprises a plurality of printed non-standard symbols, and wherein a group of values corresponds to a single barcode value.

In one embodiment of the method, the method further comprises the step of validating the data string by comparing the data string to known data strings stored in a database.

In accordance with an additional embodiment, there is provided a non-transitory computer-readable storage medium containing program code that can include, but is not limited to program code for scanning a media substrate comprising at least one printed non-standard symbol thereon; program code for identifying the at least one printed non-standard symbol, wherein the at least one printed non-standard symbol is represented by a non-standard symbol value; program code for converting the non-standard symbol value to a barcode value; and program code for converting the barcode value to a data string comprising at least one number, letter, or standard symbol. The non-transitory computer-readable storage medium containing program code can include any mobile device (as should be appreciated by those of skill in the art).

In one embodiment of the non-transitory computer-readable storage medium, the non-transitory computer-readable storage medium further comprises program code for assigning a value to each printed non-standard symbol, when the media substrate comprises a plurality of printed non-standard symbols, and wherein a group of values corresponds to a single barcode value.

The printer firmware can be updated by a host computer that is in wired or wireless communication with the firmware. Additional non-standard symbol strings, data strings, barcode values, and conversion algorithms, for example, can be transmitted to the printer memory by a computer that is in wired or wireless communication with the memory. The wireless communication/transmission can be over a network, which can be any suitable wired or wireless network capable of transmitting communication, including but not limited to a telephone network, Internet, Intranet, local area network, Ethernet, online communication, offline communications, wireless communications and/or similar communications means. Further, this data can be encrypted as needed based on the sensitivity of the data or the location the printer, for example. The computer can be located in the same room, in a different room in the same building, and/or in a completely different building and location from the digital printer. A user using the computer (or a different computer) can instruct the digital printer to print a single or any combination of non-standard symbol strings on a media substrate. An imaging device, as described herein, can similarly be in wired or wireless communication with a host computer for communication and command/control purposes.

### BRIEF DESCRIPTION OF THE DRAWINGS

The present invention will be more fully understood and appreciated by reading the following Detailed Description in conjunction with the accompanying drawings, in which:

FIG. 1 is a system architecture diagram of a digital printer that is structured, configured, and/or programmed to print a set of unique non-standard symbols for the purpose of representing a data string based on a barcode standard that can be hidden in the background of a media substrate, according to an embodiment of the present invention.

FIG. 2A is a more detailed system architecture diagram of the digital printer shown in FIG. 1, according to an embodiment of the present invention.

FIG. 2B is a system architecture diagram of an imaging device with a software application that is structured, configured, and/or programmed to scan, identify/interpret, and validate non-standard symbols set forth as a string located in the background of the digital media (with or without the assistance of a connected host computer), according to an embodiment of the present invention.

FIG. 3 is a table showing ASCII characters and the barcode 128 (A, B, or C) values corresponding to each of the ASCII character codes, which is utilized in accordance with an embodiment of the present invention.

FIG. 4A-C is a table showing code 128 values and the non-standard symbol values corresponding to each of the code 128 values, which is utilized in accordance with an embodiment of the present invention.

FIG. 5A-E are illustrations of non-standard symbols that are used as part of the hidden barcode, according to an embodiment of the present invention.

FIG. 6 is a photocopy of a digital media substrate with non-standard symbols printed thereon that was produced by a printer with printer firmware of an embodiment of the present invention, according to an embodiment of the present invention.

FIG. 7 is a flowchart showing the basic steps related to the methods and implementation thereof described in Example 1 and Example 2, according to an embodiment of the present invention.

FIG. 8 is a flowchart detailing in general a system and method for generating digital media with a hidden barcode as a record of a transaction described with respect to Example 1, according to an embodiment of the present invention.

FIG. 9 is a flowchart detailing in general a system and method for identifying and validating a hidden barcode printed on a digital media substrate by a mobile or other computer device programmed or configured to perform such identification and validation as described with respect to Example 2, according to an embodiment of the present invention.

### DETAILED DESCRIPTION

The present invention will be more fully understood and appreciated by reading the following Detailed Description in conjunction with the accompanying drawings, wherein like reference numerals refer to like components.

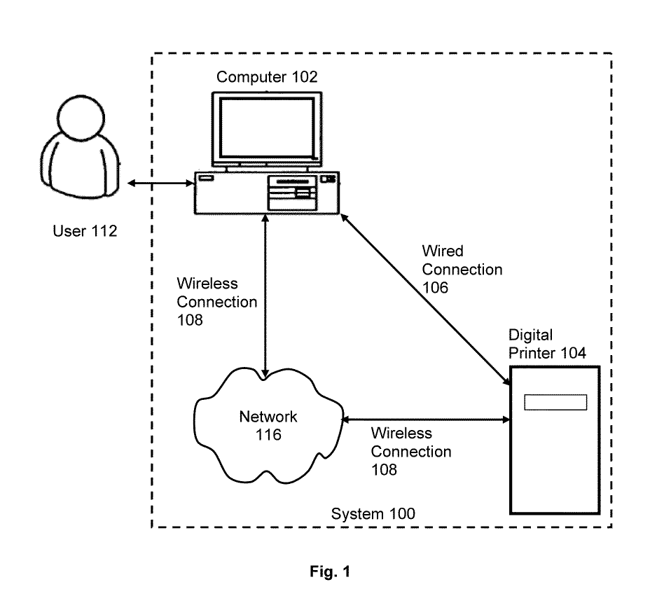

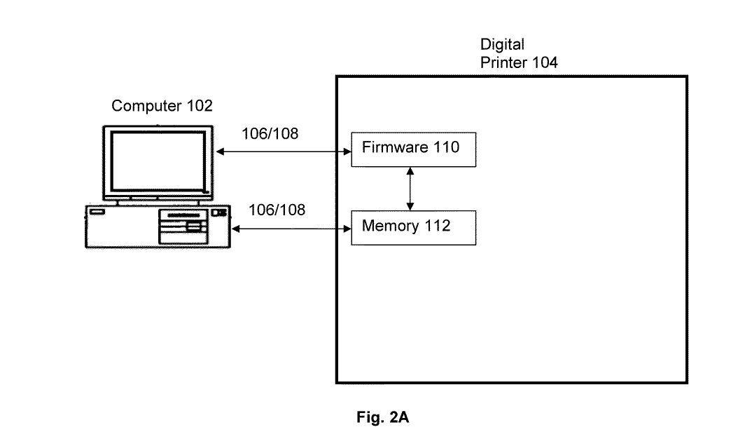

Turning to FIG. 1, a system architecture diagram showing system 100 including a digital printer 104 that is structured, configured, and/or programmed to print a set of unique non-standard symbols for the purpose of representing a data string based on a barcode standard that can be hidden in the background of a media substrate (not shown), and can have various communication links to a computer 102, according to an embodiment of the present invention is shown. Communication connections between the computer 102 and the digital printer 104, including a wired connection 106 and a wireless connection 108, are shown. A network 116 is also shown. A user 112 using the computer 102 (or a different computer) can instruct the digital printer 104 to print a set of unique non-standard symbols (loaded in memory of the printer) on a media substrate.

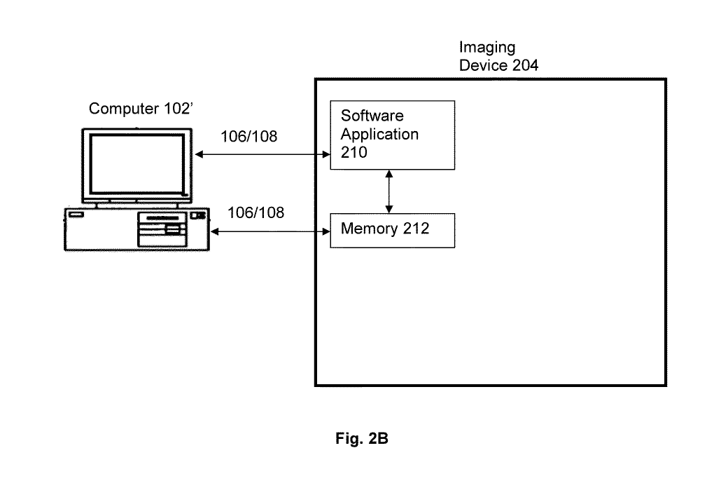

FIG. 2A shows a more detailed system architecture diagram of the digital printer 104 shown in FIG. 1, according to an embodiment of the present invention. The digital printer 104 can include a (1) memory 112 that can store and receive updates from computer 102 regarding non-standard symbol strings, related data strings and barcode values, and conversion algorithms, and (2) firmware 110 that can be programmed to (among other computer implemented methodologies described herein) accept or choose a data string comprising at least one number, letter, or standard symbol; convert the data string to a barcode value; convert the barcode value to a non-standard symbol value, wherein the non-standard symbol value is represented by at least one non-standard symbol; and digitally print the at least one non-standard symbol on a media substrate. The firmware 110 and memory 112 can have wired 106/wireless 108 communication connections to the computer 102.

FIG. 2B shows a system architecture diagram of an imaging device 204 with a software application 210 that is structured, configured, and/or programmed to scan, identify/interpret, and validate non-standard symbols set forth as a string located in the background of the digital media (with or without the assistance of a connected host computer 102′), according to an embodiment of the present invention. The software 210 and memory 212 of the imaging device 204 can have wired 106/wireless 108 communication connections to the computer 102′. This imaging device is discussed in connection with Example 2, below. The software algorithms referenced below can be resident in the memory of a circuit board that interacts with the imaging device and a display device to display the represented data.

In accordance with an embodiment, there is provided a method for digitally printing a string of non-standard and unique symbols which represent a data string (as is described further below in conjunction with the some of the referenced Figures). In brief, the data string is converted by the printer firmware 110 into a non-standard unique symbol string using a barcode standard. The printer firmware can then reduce the optical density of the symbol string by removing pixels. The optical density can be lessened to a level where the reproduction of the non-standard symbols nu standard scanners/copiers is not possible. Next, the printer firmware 110 can separate the lightened symbol string into individual symbols which can then be repositioned in predetermined cells in the print pattern. The printer firmware 110 can then add a constant noise pattern to the print pattern to further hide the symbols in the background. The lightened, disassembled symbol string with added noise pattern can then be digitally printed in the background of standard digital media in a manner which is not apparent to the untrained observer to create the hidden barcode.

The hidden barcode can then be used as a security device to deter fraud, counterfeiting, and theft by providing a barcode which is not easily detected and reproduced by counterfeiters. Once the hidden barcode is embedded on the background of the digital media, it can be used to authenticate a transaction.

Advantages of the invention are illustrated by the Examples described below with reference to certain figures illustrating various embodiments. However, the particular values, symbols, number and order of steps, as well as other conditions and details recited in the Examples, are to be interpreted to apply broadly in the art and should not be construed to unduly restrict or limit the invention in any way. As should be appreciated in the art, an infinite number/variations of data strings can be used, even though one example data string is described below.

### Example 1

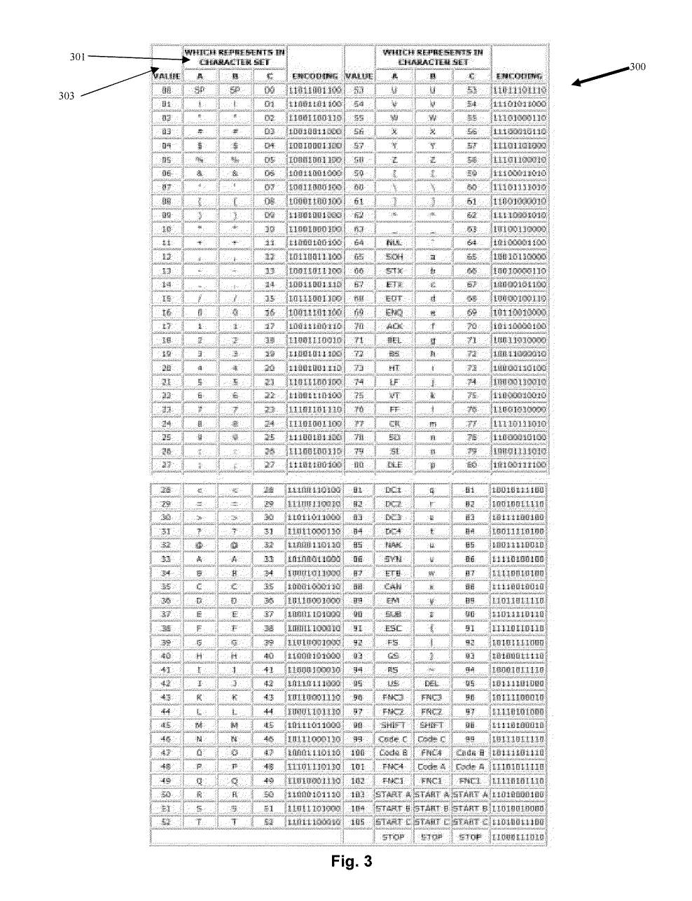

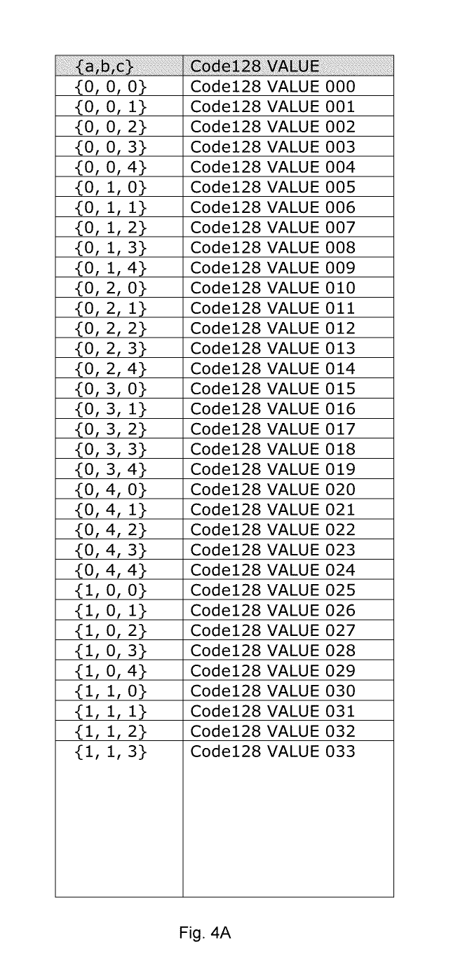

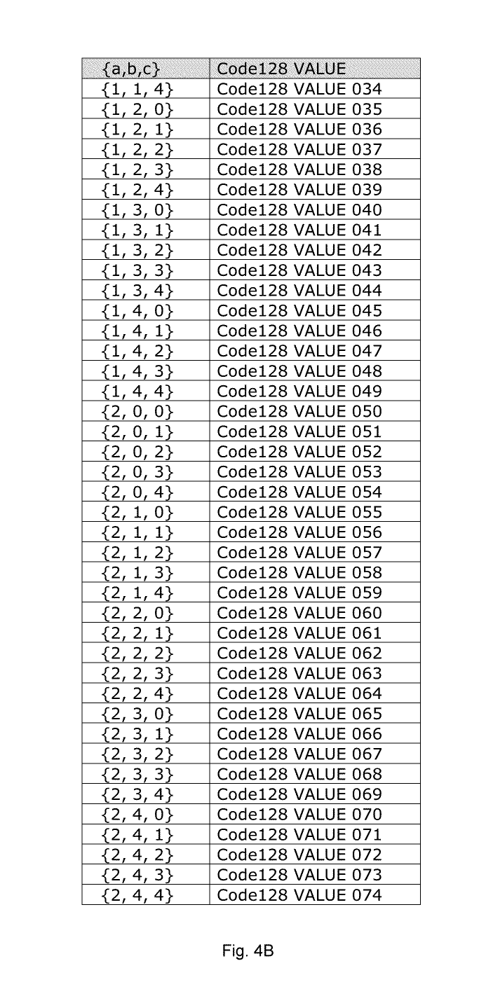

This Example describes the creation and printing of a hidden barcode based on a data string (which can include at least one number, letter, or standard symbol), according to an embodiment. Turning to FIG. 3, a table showing columns with ASCII characters 301 for barcode 128 code sets A, B, and C, and a barcode 128 “value” 303 for each of the ASCII characters 301 is provided according to an embodiment. In order to create and print at least one unique non-standard symbol for the purpose of representing a data string based on a barcode standard that can be hidden in the background of a media substrate, a user, the computer 102, or the printer firmware 110 can choose a data string. Once the data string is chosen, the printer firmware 110 can utilize the table shown in FIG. 3 by matching each portion of the data string under one of the columns represented by ASCII characters 301 for barcode 128 code sets A, B, and C with a corresponding barcode 128 value in column 303.

For example, a user can choose the following ASCII data string—HAPPY—to be encoded/converted into a barcode 128 A. In order to convert this data string into a barcode 128 value, the printer firmware 110 obtains the value in the “Value” column corresponding to each letter in “HAPPY” from column “A” in order as follows:

| ASCII | Barcode 128 Value 303 (from |
|---|---|
| Character 301 (from column “A”) | “Value”column) |
| H | 40 |
| A | 33 |
| P | 48 |
| P | 48 |
| Y | 57 |

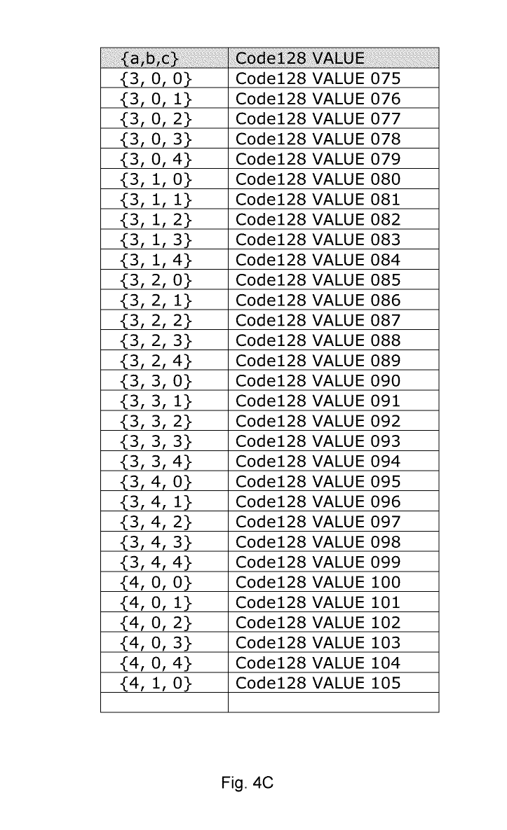

In the next step, the barcode 128 values under the “Value” Column above are converted by the printer firmware 110 to non-standard symbol values per use of the table shown in FIG. 4A-C as follows. Each of the barcode 128 “Value” numbers are located by the printer firmware 110 in the “Code 128 Value” column, and then converted to a corresponding three number/symbol value obtained in the “{a, b, c}” column. The specific corresponding three number values for the “HAPPY” example are as follows:

| Code 128 Value | {a, b, c} Value |
|---|---|
| 40 | {1, 3, 0} |
| 33 | {1, 1, 3} |
| 48 | {1, 4, 3} |
| 48 | {1, 4, 3} |
| 57 | {2, 1, 2} |

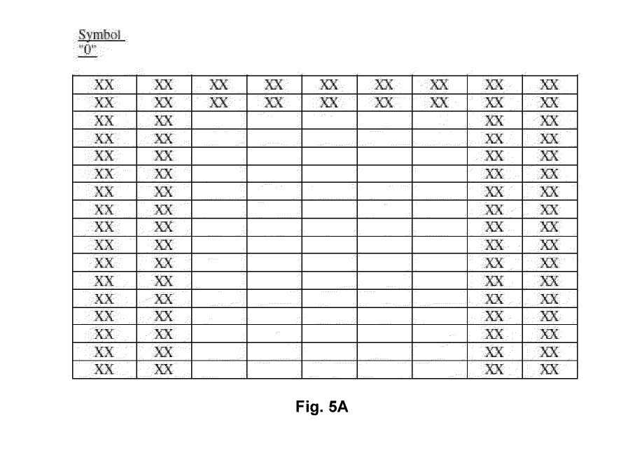

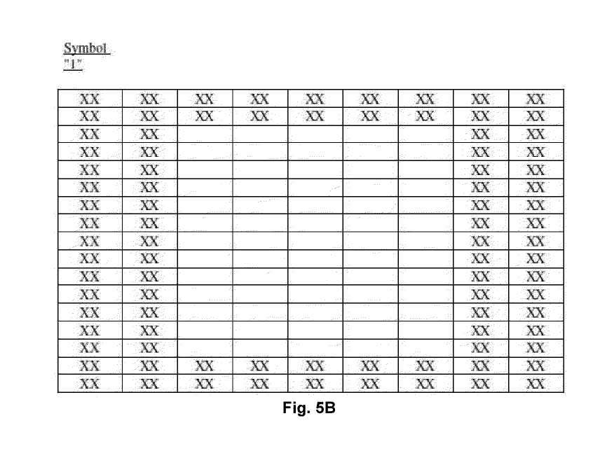

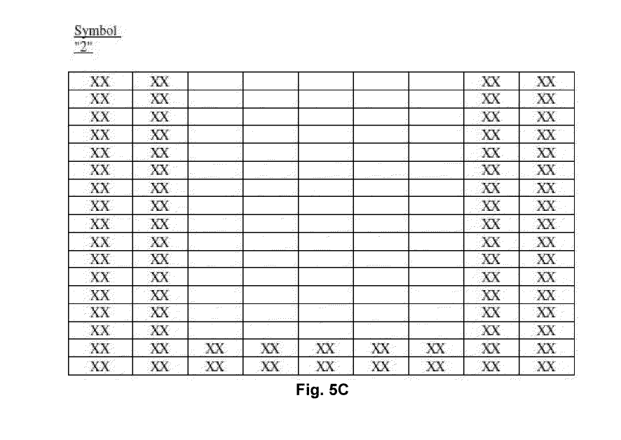

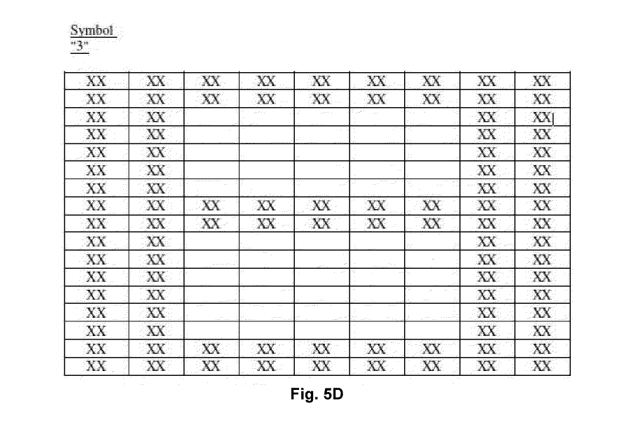

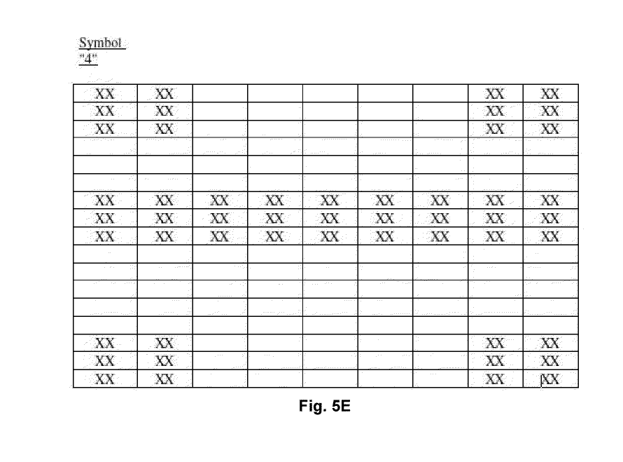

In the next step, the values from the “{a, b, c} Value” column above are merged by the printer firmware 110 into a first order sequence or one string for printing as follows—1, 3, 0, 1, 1, 3, 1, 4, 3, 1, 4, 3, 2, 1, 2. Each of these numbers are then converted to a corresponding non-standard symbols shown in FIG. 5A-E representative of numbers 0-4 (Non-Standard “Symbols” 0-4), and then printed (preferably post additional processing, discussed below) on digital media in the sequence represented by the numbers above as follows—non-standard symbol 1, non-standard symbol 3, non-standard symbol 0, non-standard symbol 1, non-standard symbol 1, non-standard symbol 3, non-standard symbol 1, non-standard symbol 4, non-standard symbol 3, non-standard symbol 1, non-standard symbol 4, non-standard symbol 3, non-standard symbol 2, non-standard symbol 1, non-standard symbol 2. Each of the five non-standard symbols are shown in dot matrix form as could be printed by the printer. The matrix shown is 9 dots wide by seven dots long, but can be of any reasonable size.

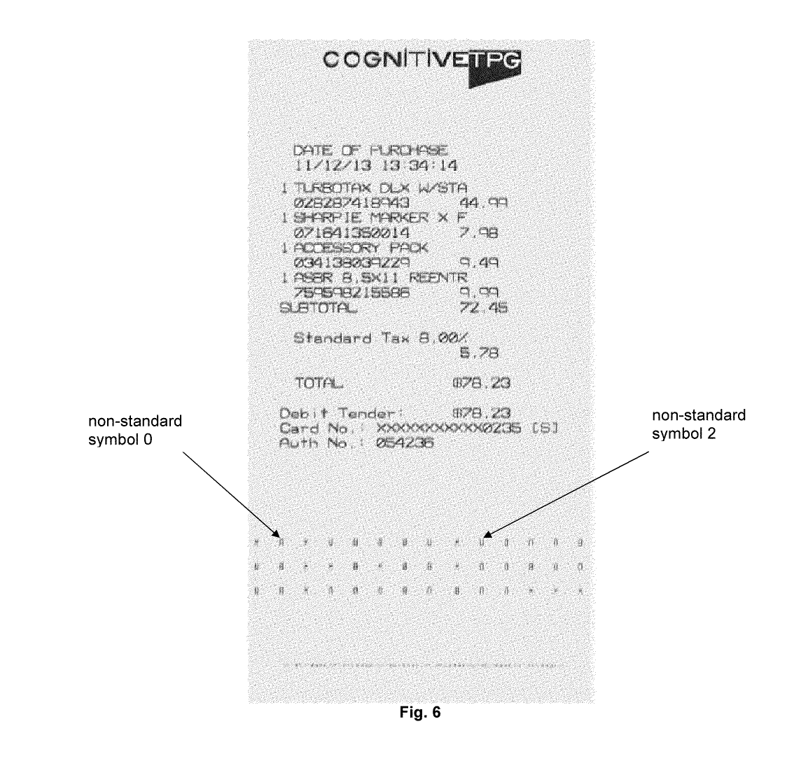

Turning to FIG. 6, a hidden barcode including nonstandard symbols are shown with a noise pattern printed over the symbols on a sample receipt (digital media substrate), according to an embodiment. Non-standard symbols “0” and “2” are highlighted for illustrative purposes.

In one embodiment of the method, the method further comprises the steps of reducing optical density of the non-standard symbols described in Example 1, parsing the non-standard symbols into different predetermined cells in the background of the digital media, and/or printing a constant noise pattern on top of the non-standard symbols by the printer firmware 110, and then digitally printing the now “hidden” barcode on digital media.

### Example 2

This Example describes the identification and validation of the hidden barcode printed on a digital media substrate by a mobile or other computer device (“imaging device”) programmed or configured to perform such identification and validation. This is accomplished, in part, by a mobile or other computer device programmed or configured to scan, enhance, process and/or identify the hidden barcode with the non-standard symbols thereon, convert the non-standard symbols to a barcode value, and convert the barcode value to a data string including at least one number, letter, or standard symbol. This overall processing (or parts thereof) may occur, for example, inside an embedded controller or ASIC inside the imaging device, or within software stored in the resident memory of another PC, controller, or host connected to (wired or wirelessly) and in communication with the imaging device.

The imaging device is programmed and/or configured to scan the media substrate including the hidden barcode with the non-standard symbols thereon. The hidden barcode processing can include, but is not limited to, applying a filter to remove the constant noise pattern from the scanned image of the hidden barcode. Next, the imaging device is programmed or configured to search inside the predetermined cells (area) of the image of the hidden barcode for each non-standard symbol. Once the individual non-standard symbols are located in the predetermined cells, the imaging device is programmed or configured to assemble the individual non-standard symbols into a symbol string. Finally, the mobile or other computer device is programmed or configured to darken the newly assembled non-standard symbol string by filling in the missing pixels, which may have been removed with the optical density reducer (as described above).

The imaging device is programmed or configured to process the processed symbol string with a software algorithm, which first recognizes each of the individual symbols in the string. Once the string is recognized, the algorithm can then be used to interpret the symbols and assign a number to each. The string of numbers can then be segmented into groups of three {a,b,c}. Each symbol segment can be run through a software algorithm to establish (i.e., be converted into) the corresponding barcode value. The software algorithm used to convert the symbol pairing {a, b, c} into the code 128 value can be:

Code 128 value=a*5̂2+b*5̂1+c*5̂0=a*25+b*5+C

Using a barcode standard (as described with respect to Example 1), this barcode value is used to reveal the ASCII character string (data string) being represented by the hidden barcode. The imaging device is programmed or configured to then send the data string to a display device so the user can see the interpreted data. The data string can also be sent to a validation database where it is checked for its validity.

In accordance with a further embodiment, a printed circuit board can be attached to the imaging device within which there exists an algorithm that is used to identify and/or filter identified repeating patterns, and to identify data associated with non-standard symbols printed on digital media.

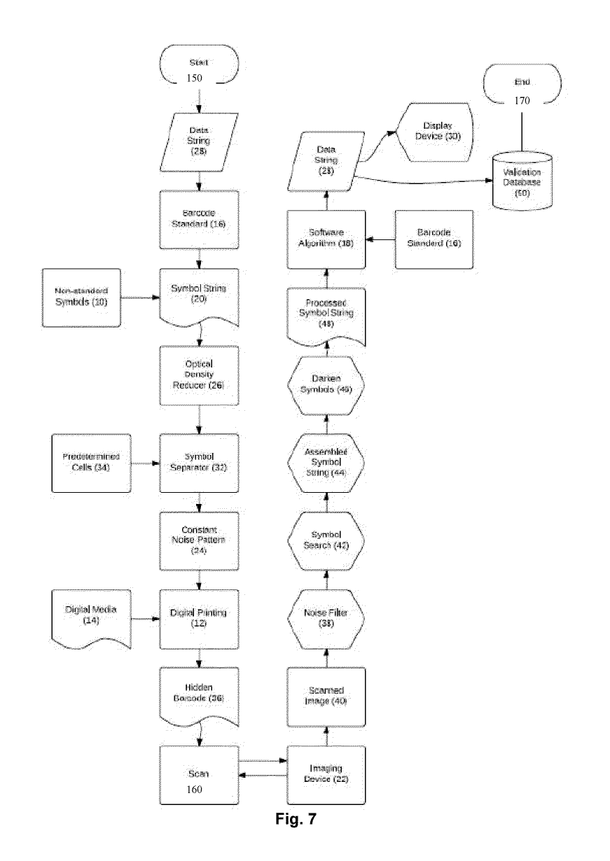

Turning to FIG. 7, a flow chart is shown illustrating the basic steps related to the methods and implementation thereof described in Example 1 and Example 2 (i.e., process for creating the hidden barcode and how the barcode is decoded, validated and displayed). For example, the process described with respect to Example 1 starts at “Start” 150, followed by the selection and/or acceptance of a data string 28. The data string is then converted into a barcode standard 16, the barcode standard 16 is converted into a symbol string 20, and the symbol string 20 (which is a group of non-standard symbols 10) ultimately representing the original data string. An optical density reducer 26 can be applied to remove pixels from the symbol string 20 to make the symbols appear lighter in the background of the digital media 14 so that they appear less obvious to an untrained observer. The symbol separator 32 is used to parse the symbol string 20 into different predetermined cells 34 (areas) in the background of the digital media 14. A constant noise pattern 24 can be printed on top of the non-standard symbols 10 in the background of the digital printing. Once the symbol string 20 has been lightened, separated, and merged with a constant noise pattern 24, it becomes the hidden barcode 36. The hidden barcode 36 is then printed in the background of digital media 14 using digital printing 12 techniques (see FIG. 6). Once the hidden barcode 36 is embedded on the background of the digital media 14, it can be used to authenticate a transaction.

The holder of the digital media 14 with the hidden barcode 36 can present the media so that a transaction can be authenticated.

The process described with respect to Example 2 above starts at scan 160 performed by an imaging device 22 to obtain a scanned image 40 of and to read the hidden barcode. The imaging device then puts the scanned image 40 through several processes. The image processing may occur inside an embedded controller or ASIC inside the imaging device or the processing may occur through software stored in the memory of a remote PC, controller or other host.

In brief, additional steps include application of the noise filter 38 to filter out a constant noise pattern. A symbol search 42 can be performed to identify the symbols in each of the predetermined cells 34 and then merge them into the assembled symbol string 44. Finally, the image processing can darken symbols 46 by filling in the missing pixels from the assembled symbol string 44 to form the processed symbol string 48. The processed symbol string 48 is then processed with a software algorithm 18 which first recognizes each of the individual symbols in the string. Once the processed symbol string 48 is recognized, the software is programmed to interpret the symbols and assign a number to each. The processed symbol string 48 is then segmented into groups of three symbols {a,b,c}. Each symbol group is then run through a software algorithm 18 to establish the barcode value. Using a barcode standard 16 (see FIG. 3), this barcode value is used to reveal the ASCII character string (data string 28) being represented by the hidden barcode. The imaging device 22 then sends the data string 28 to a display device 30 so the user can see the interpreted data. The data string 28 is also sent to a validation database 50 where it is checked for its validity. The process ends at 170.

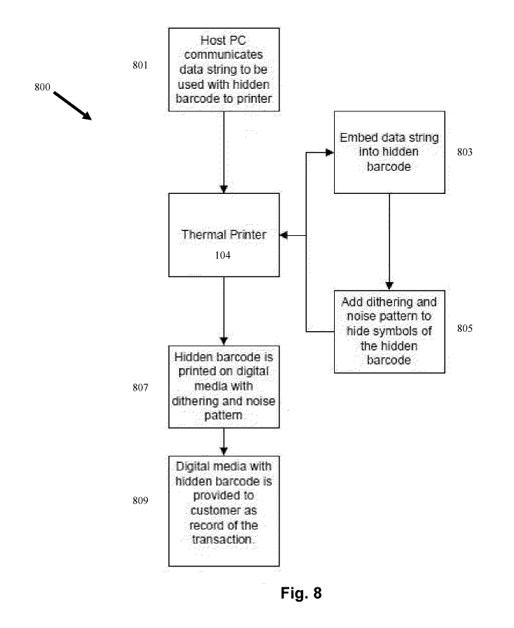

Turning to FIG. 8, a flow chart 800 is provided detailing in general a system and method for generating digital media with a hidden barcode as a record of a transaction described with respect to Example 1. The flow chart 800 illustrates that a majority of the functionality occurs within the printer carried out by the printer firmware 110. At step 801, the host computer 102 communicates a data string to the printer 110 with printer firmware 110 to be converted to a hidden barcode (as described above). In brief, the minter 110 can embed/convert the data string into a hidden barcode at step 803, and add dithering and a noise pattern to hide the non-standard symbols of the hidden barcode at step 805. At step 807, the hidden barcode is printed on digital media with dithering and a noise pattern (and other “hiding” treatments as described above and/or which may be understood by those of skill in the art). At step 809, the digital media (e.g., a transaction receipt, event ticket, coupon or gaming ticket, product labels) with the hidden barcode can be provided to a customer as a record of a transaction.

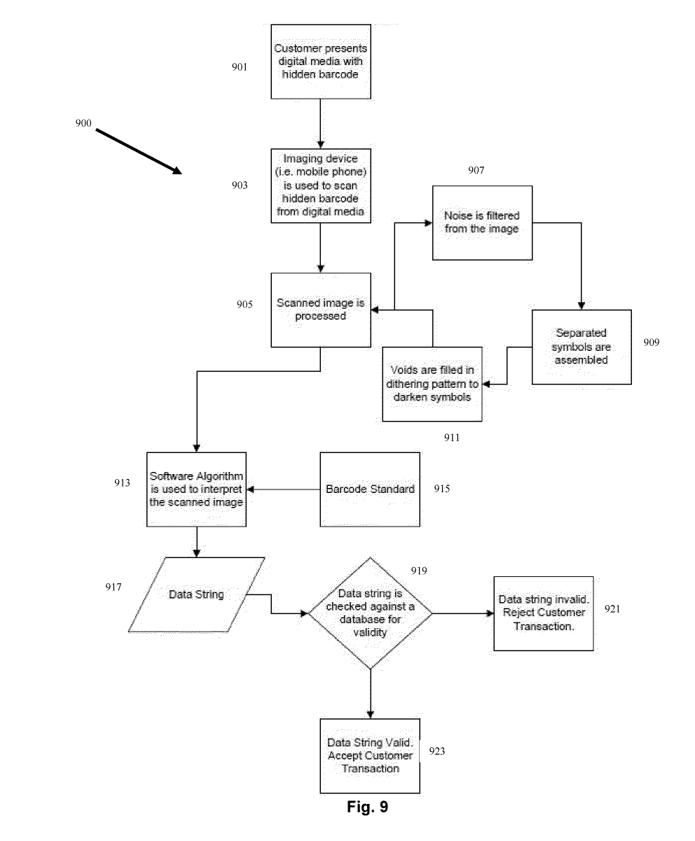

Turning to FIG. 9, a flow chart 900 is provided detailing in general a system and method for identifying and validating a hidden barcode printed on a digital media substrate by an imaging device programmed or configured to perform such identification and validation as described with respect to Example 2. At step 901, a customer presents digital media (e.g., a receipt) with a hidden barcode (preferably prepared according to the process described with respect to Example 1). At step 903, an imaging device is programmed or configured to be used to scan the hidden barcode from the digital media. At steps 905-911, the scanned image is processed (step 907—noise is filtered from the image; step 909—separated symbols are assembled; step 911—voids are filled in dithering pattern to darken symbols). At step 913, a software algorithm is used to interpret the scanned image by converting symbol pairing into code 128 value at step 915. At step 917, the data string is determined (as described above), which can be checked against a databased for validity at step 919. If the data string fails the check for validity (which can be performed at by the imaging device, or by a host computer that is in wired or wireless communication with the imaging device), the customer transaction can be rejected at step 921. If the data string passes the check for validity, the customer transaction can be accepted at step 923.

A “module,” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, completely or partly on the printer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While several embodiments of the invention have been discussed, it will be appreciated by those skilled in the art that various modifications and variations of the present invention are possible. Such modifications do not depart from the spirit and scope of the present invention.

What is claimed is:

1. A computer implemented method for digitally printing a non-standard symbol string representing a data string, the method comprising:
accepting a data string comprising at least one number, letter, or standard symbol;
converting said data string to a barcode value;
converting said barcode value to a non-standard symbol value, wherein said non-standard symbol value is represented by at least one non-standard symbol; and
digitally printing said at least one non-standard symbol on a media substrate.

2. The method of claim 1, wherein the step of accepting further comprises the step of accepting a data string comprising a plurality of any combination of at least one number, letter, or standard symbol.

3. The method of claim 2, wherein the step of converting said data string to a barcode value further comprises the step of converting each of said plurality of any combination of at least one number, letter, or standard symbol to a separate barcode value.

4. The method of claim 3, wherein the step of converting said barcode value to a non-standard symbol value further comprises the step of converting each separate barcode value to a corresponding separate non-standard symbol value, wherein each of said corresponding separate non-standard symbol values is represented by at least one non-standard symbol.

5. The method of claim 4, further comprising the step of merging each of said corresponding separate non-standard symbol values in a first order sequence.

6. The method of claim 5, wherein the step of digitally printing further comprises the step of digitally printing said non-standard symbols in said first order sequence on said media substrate.

7. The method of claim 1, further comprising the step of reducing optical density of said at least one non-standard symbol.

8. The method of claim 6, further comprising the step of parsing the non-standard symbols into different predetermined cells in the background of the digital media.

9. The method of claim 1, further comprising the step of printing a constant noise pattern on top of said at least one non-standard symbol.

10. A non-transitory computer-readable storage medium containing program code comprising:
program code for accepting a data string comprising at least one number, letter, or standard symbol;
program code for converting said data string to a barcode value;
program code for converting said barcode value to a non-standard symbol value, wherein said non-standard symbol value is represented by at least one non-standard symbol; and
program code for digitally printing said at least one non-standard symbol on a media substrate.

11. The non-transitory computer-readable storage medium of claim 10, further comprising program code for accepting a data string comprising a plurality of any combination of at least one number, letter, or standard symbol.

12. The non-transitory computer-readable storage medium of claim 11, further comprising program code for converting each of said plurality of any combination of at least one number, letter, or standard symbol to a separate barcode value.

13. The non-transitory computer-readable storage medium of claim 8, further comprising program code for converting each separate barcode value to a corresponding separate non-standard symbol value, wherein each of said corresponding separate non-standard symbol values is represented by at least one non-standard symbol.

14. The non-transitory computer-readable storage medium of claim 11, further comprising program code for merging each of said corresponding separate non-standard symbol values in a first order sequence.

15. The non-transitory computer-readable storage medium of claim 12, further comprising program code for digitally printing said non-standard symbols in said first order sequence on said media substrate.

16. A computer implemented method for revealing and validating a data string represented by at least one non-standard symbol printed on a media substrate, the method comprising:
scanning a media substrate comprising at least one printed non-standard symbol thereon;
identifying said at least one printed non-standard symbol, wherein said at least one printed non-standard symbol is represented by a non-standard symbol value;
converting said non-standard symbol value to a barcode value; and
converting said barcode value to a data string comprising at least one number, letter, or standard symbol.

17. The method of claim 16, further comprising the step of assigning a value to each printed non-standard symbol, when the media substrate comprises a plurality of printed non-standard symbols, and wherein a group of values corresponds to a single barcode value.

18. The method of claim 16, further comprising the step of validating said data string by comparing said data string to known data strings stored in a database.

19. A non-transitory computer-readable storage medium containing program code comprising:
program code for scanning a media substrate comprising at least one printed non-standard symbol thereon;
program code for identifying said at least one printed non-standard symbol, wherein said at least one printed non-standard symbol is represented by a non-standard symbol value;
program code for converting said non-standard symbol value to a barcode value; and
program code for converting said barcode value to a data string comprising at least one number, letter, or standard symbol.

20. The non-transitory computer-readable storage medium of claim 19, further comprising program code for assigning a value to each printed non-standard symbol, when the media substrate comprises a plurality of printed non-standard symbols, and wherein a group of values corresponds to a single barcode value.
